(19) United States
(12) Patent Application Publication
(10) Pub. No.: US 2013/0245366 A1
(43) Pub. Date: Sep. 19, 2013

(54) Medical Device to Aid in Ejaculation

(71) Applicants: Matthew Towner Rhodes, Napa, CA (US); Michael Paul Blasetti, Long Beach, CA (US)

(72) Inventors: Matthew Towner Rhodes, Napa, CA (US); Michael Paul Blasetti, Long Beach, CA (US)

(21) Appl. No.: 13/800,196

(22) Filed: Mar. 13, 2013

Related U.S. Application Data
(60) Provisional application No. 61/611,100, filed on Mar. 15, 2012.

(51) Int. Cl. A61H 19/00

(52) U.S. Cl. CPC A61H 19/30
USPC 600/38

(57) ABSTRACT

A penile stimulation device allowing a great degree of control of stimulation level to the user, and that minimizes frictional forces that may cause irritation or damage is disclosed. The device preferably takes the form of a glove, which may be formed generally of a flexible, resilient, rubber-like material that simulates the feel of human flesh, and that comprises on its outside a flexible webbing membrane further comprising an aperture surrounded by an annular ring. The device further comprises a plurality of ribs and protuberances.

This application claims priority from the U.S. provisional application with Ser. No. 61/611,100, which was filed on Mar. 15, 2012. The disclosure of that provisional application is incorporated herein as if set out in full.

### BACKGROUND

1. Field of the Invention

The present invention relates to a medical device to aid in masturbation, and more particularly to an erotic simulator and device for assisting males with the ejaculation of sperm through the use of a masturbation aid.

2. Background of the Invention and Description of the Prior Art

### Background of the Invention

Generally, in the male penis an erection involves the central nervous system, the peripheral nervous system, psychological and stress-related factors and local factors within the penis itself. When one or more of the above physical or psychological factors is disrupted, erectile dysfunction may result. There are thus myriad systems to aid in the ejaculation of sperm, some of which may be used with the aid of a partner for the male, and others that may be used without. For the latter, such solutions have conventionally spanned from the medical to the sex novelty industries, with many devices bridging the gap and applying to both.

Medical aids for simulating a female sex organ for purposes of a masturbatory sexual act carried out by a male may be well known in certain areas of society, but have a long, largely unreported history. Patents for such devices nevertheless do date back at least to the beginning of the last century. As one of the oldest patented examples, U.S. Pat. No. 844,798 to Louis B. Hawley provides an early patented example of an appliance for “assisting anatomical organs in the performances of their natural functions”, and more specifically had the object of “temporarily endowing the debilitated and otherwise impotent organ with the capabilities in which it is found wanting, and thus attain permanent relief for the suffer”. This early device is one in a long line of many for assisting in masturbation, and by and large they utilize known and familiar, expected, and or obvious structural configurations.

There are thus scores of male sexual organ stimulation devices in the medical and sex novelty industries. Medical devices such as these may be useful to sperm banks and/or to medical or psychiatric doctors seeking additional means for treating those with sexual disorders such as erectile dysfunction (“ED”). Individuals may use these devices for personal use in addition to medical use, either to decrease the transmission of sexually transmitted disease, decrease dependency on prostitution, or for other personal reasons.

One common use for such devices is during exercise of the pubococcygeal, or PC muscle. As one method of treatment of ED, medical professionals have prescribed Kegel exercises, where a man repeatedly extends and contracts the pubococcygeal muscle so as to gradually build up its strength, thereby leading to an improvement in the sexual function of the patient. While the pubococcygeal muscle may be exercised while the penis is not erect, the effectiveness is increased if an erection is maintained during exercise by a controlled level of stimulation. There is thus a likelihood that through frictional engagement between the male organ and a sexual device, that the organ may become irritated or damaged over time, especially if such use is extended. This defeats their purpose and will hinder the man's rehabilitation. Furthermore, many of the conventional devices provide the user with very little control over the level of stimulation.

Another common use for such devices is involved in the collection and donation of semen. Some donors may consider semen collection by condom difficult, or may have difficulty in producing ejaculate for collection. There exist a number of previous inventions; each describing means intended to eliminate these and other factors involved in the collection and donation of semen. To these and other ends the invention comprises certain improvements and combinations of parts, all as will be hereinafter more fully described.

### Description of Related Art

For example, U.S. Pat. No. 5,501,650 to Reinhard R. Gellert discloses an automated variable speed motor device that powers a crankshaft driven sealed transducer producing a pneumatically induced reciprocating motion of a receiver when a male organ is inserted therein. This automated masturbatory device is complex, complicated and potentially dangerous to the male organ when reciprocating at the described 350 automated pneumatically induced reciprocations per minute.

As an older example, U.S. Pat. No. 1,383,944 to Lewis B. Hart discloses an adjustable sleeve-like member adapted to receive and hold the male organ sufficiently rigidly to prevent penetration therefrom. The device is elastic, pliable and comprises a smooth inner and outer surface for comfort to the user.

U.S. Pat. No. 5,458,559 is an artificial vagina comprising a tapered sheath of flexible waterproof material, the larger end of which has an opening re-sealable by a removable closure member, the closure member having releasable means to connect with the other end of the sheath to pull this into the sheath so that a fluid chamber is formed between the inwardly folded end and the wall of the end of the sheath. The assembled sheath, when filled with warn water, becomes a warm, soft envelope capable for receiving a suitably lubricated male organ.

U.S. Pat. No. 5,695,446, to Jukka Lindholm-Ventola is similar artificial vagina used in animal breeding and which includes a heatable tubular jacket with a tubular interior component made of a resilient material, surrounded by the jacket and fastened to it in a fluid-tight manner to define an annular chamber between the jacket and the interior component.

U.S. Pat. No. 5,782,818 is a device for discreet sperm collection invented by Steven A. Shubin. The device comprises an outer shell having a tubular inside chamber, all within a device normally found in a public environment such as a flashlight or beverage bottle. The chamber is filled with an insert formed from an elastomeric gel having the general tactile feel of human flesh, sized to accommodate a human male sex organ.

U.S. Pat. No. 5,876,324 to Trouchine provides a penile stimulation device for use in the treatment of male impotence, the device utilizing turbulent flow of fluid and comprising a tubular housing means having internal walls, a closed forward end and an open rearward end, said rearward end having an opening means for encircling the penile shaft, for housing the penis submersed in fluid and disposed at a sufficient distance from said internal walls to permit fluid flow between the penis and said internal walls, and a pump for conveying a flow of turbulent fluid between the penis and said internal walls in and out of the housing

U.S. Pat. No. 6,149,580 provides a core member formed in a cylindrical configuration and fabricated of a generally rigid plastic material but surrounded by a flexible, resilient, rubber-like material such as latex. End regions of a surrounding member are stretched into contact with the exterior surface of the surrounding member within the core member. Finally, a lubricant is provided that covers the interior surface of the surrounding member within the core member.

U.S. Pat. No. 6,306,080 is a disposable penile constriction device comprising a strip of flexible and elastic material in the form of a closed curvilinear figure. This figure is placed in such a manner that the internal surface of the flexible material is located around the penis, forming an aperture. A fastener is provided to secure the device around the penis.

U.S. Pat. No. 6,669,657 is a massage and tactile stimulation device to Deanna Ongwela that provides a device in the nature of a hand covering such as a mitt, mitten or glove and which is to be worn on the hand of a masseur, therapist, or user. The device has one or more predetermined prominent projections with or without friction areas, the projection areas secured to the effective working area of the glove to impart to a subject or patient a variety of distinct and improved manipulations such as deep pressure, grasping, and frictional rubbing.

U.S. Pat. No. 7,753,895 is a sperm collecting apparatus invented by Tsutomu Matsuura, the apparatus comprising a container having a non-cylindrical main unit having on one end an open face and a cap attachable thereto. Inside the main unit is a gel-like core member and a sponge layer interposed between the core member and an inner wall of the main unit. U.S. Pat. No. 7,993,315, to the same inventor, is a similar device comprising a cylindrical container main unit with a similar opening and cap, but further comprising a plurality of ribs provided upright from the outer face of the core main unit so as to cross one another.

U.S. Patent Publication No. 2006/0047182 is a stimulator device for a male sexual organ that is a suction and artificial vagina device. The device comprises a soft plastic cylindrical container having an open end that forms a cavity for receiving the male sexual organ. The device further includes unattached free-moving membrane-like material within which tap water is sealed inside and said material thus inserted, entirely within the said container. The device is the only device in the medical and sexual aid fields that can easily be assembled at home and provides simultaneous sucking action and realistic-like membranous tactile sensation to the male sexual organ replicating the female vagina.

While these devices fulfill their respective, particular objectives and requirements, the aforementioned patents and patent publication do not describe a medical device to aid in the masturbation that provides a high degree of control to the user, emphasizes frictional forces that stimulate the penis but minimizes frictional forces that may cause irritation or damage, provides a clean surface for contact with the penis and provides a barrier between the penis and the user's hand. They thus alone or in combination fail accomplish the objectives of the present invention.

It is thus a first objective of the invention to provide an improved and simple device to aid in masturbation and which may be used to assist in the ejaculation of sperm through use of a masturbation aid.

It is a second objective of the invention to provide a means for stimulation of a penis that provides a high degree of control to the user.

It is a third objective of the invention to provide a means for stimulation of a penis that emphasizes frictional forces that stimulate the penis but minimizes frictional forces that may cause irritation or damage.

It is a fourth objective of the invention to provide a clean surface for contact with the penis and which provides a barrier between the penis and the user's hand.

It is a fifth objective of the invention to provide a clean surface for a wearer to use while making physical contact with himself, herself, or another.

In this respect, the medical device disclosed herein and according to the present invention substantially departs from the conventional concepts and designs of the prior art, and in doing so provides an apparatus primarily developed for the purpose of assisting in the ejaculation of sperm through the user of masturbatory aid. It can thus be appreciated that there exists a continuing need for a new and improved medical device to aid in masturbation and which can be used for assisting in the ejaculation of sperm through the user of a masturbatory aid.

### SUMMARY OF THE INVENTION

The invention provides a novel penile stimulation device in the form of a glove that is firmly secured to the wearer's hand and provides the user with among other things, a high degree of tactile control to the level of stimulation self-applied by the user, and a means for minimizing frictional forces that may cause irritation or damage. The device preferably takes the form of a hand covering having a specialized aperture, the hand covering formed generally of a flexible, resilient, rubber-like material that simulates the feel of human flesh. The device may be made of natural materials, synthetic materials, or blends.

The device may aid in masturbation of a human male, and provides a clean barrier between the male organ and the user's hands. The device may also be used for the sexual stimulation of others and may be used in the animal breeding industry as described below.

### BRIEF DESCRIPTION OF THE FIGURES

The foregoing aspects and many of the attendant advantages of the invention will become more readily appreciated as the same becomes better understood by reference to the following detailed description, when taken in conjunction with the accompanying drawings, wherein:

FIG. 1 is a top perspective view of the invention showing elements of a first and preferred embodiment;

FIG. 2 is a bottom perspective view of the invention showing elements of the first embodiment; and

FIG. 3 is a plan view of the invention showing elements of the first embodiment in a right hand configuration.

FIG. 4 is a plan view of the invention showing elements of the first embodiment in a left hand configuration.

FIG. 5 is a perspective view of the invention showing elements of an alternative embodiment;

FIG. 6 is a perspective view of the invention showing elements of a second alternative embodiment;

FIG. 7 is a perspective view of the invention showing elements of a third alternative embodiment; and

FIG. 8 is a perspective view of the invention showing elements of a fourth alternative embodiment.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

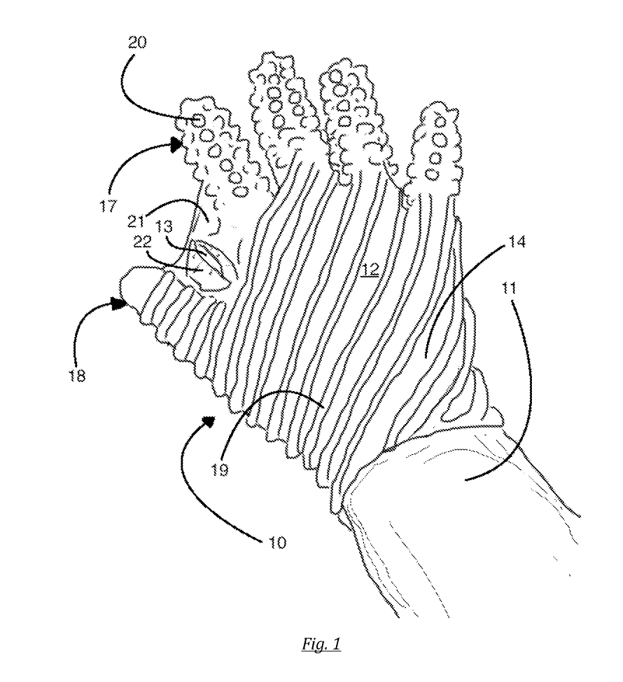

FIG. 1 illustrates a top view of one embodiment of a novel penile stimulation device in the form of a glove 10 that is firmly secured to the hand of a wearer 11 and providing the wearer 11 with among other things, a high degree of tactile control to the level of stimulation self-applied by the user. The glove 10 comprises an outside side 12 preferably made up of a soft material that minimizes frictional forces that may otherwise cause irritation or damage. The outside side 12 is shown here on the top view of the device but as seen in the subsequent figures wraps around to the bottom side of the device as well. The outside side 12 may be formed generally of a flexible, resilient, rubber-like material that simulates the feel of human flesh. The novel penile stimulation device may be made of natural materials, synthetic materials, or blends. In general the device is soft, yet robust. Preferably, the outside side 12 is a thermoplastic elastomer and/or a mixture of polyvinyl chloride and silicone. The pigment of the outside side 12 and the remainder of the glove may be modified through the addition of dies or pigments of various colors.

In one embodiment the outside side 12 comprises an elastomeric gel, such as those gels disclosed in a number of patents to John Chen, including U.S. Pat. Nos. 4,369,284, 4,618,213, 5,153,254, 5,262,468, 5,334,646, and 5,336,708, and which describe various gelatinous materials comprising an admixture of poly(styrene-ethylene-butylene-styrene) triblock copolymers having styrene end block to ethylene and butylene center blocks with various ratios as described in the patents, and further comprising levels of plasticizing oils ranging from 3 to 16 parts oil per part copolymer. Additional elastomeric gels may be found in the prior art.

One such material is known by the brand name CyberSkin® and is owned by Vast Resources, Inc. located in Chatsworth, Calif., sold by Topco Sales (also located in Chatsworth, Calif.), and which comprises a soft elastomer material that it intended to emulate the feel of human skin. Similar other materials are available under other brand names, such as Ultraskin™, Eroskin™, Softskin™, SoftTouch™, Cyber Jel-lee™, New supersoft™, Futurotic®, and URL™ (Ultra Realistic 3.0).

The novel penile stimulation device outside side 12 may in an alternative embodiment comprise a styrene-ethylene propylene-styrene block copolymer, hereinafter called SEPS, which is highly extended with oil such as mineral oil, such that the ratio of SEPS to oil is carefully controlled to simulate the tactile feel of flesh. This material is described in U.S. Pat. No. 5,807,360 (Device for Discreet Sperm Collection) to Steven A. Shubin. Preferred are SEPS polymers having a number average molecular weight of at least 150,000 to 200,000. Other oils may include white mineral oil, naphthenic oils, and synthetic oils such as Shellflex® 371, manufactured by Shell Chemical Co. Other oils include petroleum paraffinic oils, petroleum naphthenic oils, synthetic polybutene oils, synthetic polypropene oils, synthetic polyterpene oils and mixtures thereof. It is to be understood that the above-described elastomeric gel is but one material of which the outside side 12 may be made. Other flesh-like or soft yet durable materials may be used in the construction of the glove as are known in the art.

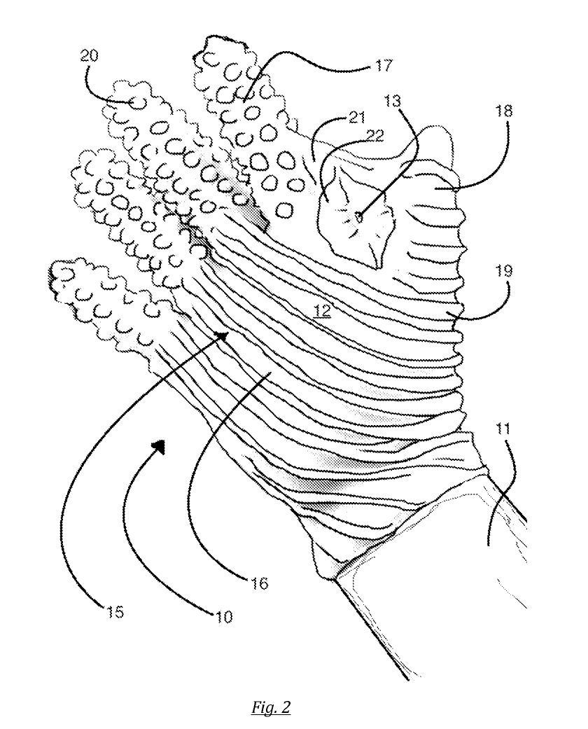

The outside side 12 further comprises a backhand side 14, and a palm side 15 (see FIG. 2) connected together and forming an opening for receiving the hand of the wearer 11. The backhand side 14 and the palm side 15 are joined together to fit a human hand of the wearer 11, wherein said backhand side 14 is formed and disposed so as to overlie the back of the hand of the wearer 11 when worn.

Turning to FIG. 2, said palm side 15 can be seen to include a palm face portion 16, at least one finger sleeve portion 17, and a thumb portion 18. The at least one finger sleeve portion 17 is shared with said backhand side 14 as shown on FIG. 1. Both said palm side 15 and said backhand side 14 comprise a plurality of ribbed contours, or ribs 19. FIGS. 1 and 2 depict said ribs 19 wrapping around the majority of the palm side 15 and backhand side 14. Both FIGS. 1 and 2 also depict said at least one finger sleeve portion 18 dotted with a plurality of protuberances 20. The protuberances are small three-dimensional domelike gripping structures that create greater traction for increased tactile control. In other embodiments they may be substituted by other textured surfaces, such as indentations, crosses, waffle-like surfaces, and the like. As shown on FIG. 1, four is the preferred number of said at least one finger sleeve portions 17, and each is labeled as such in FIG. 1 and shown with its respective protuberances 20.

In use, as the distal end of the penis repeatedly passes through the narrowed and widened passage formed by the ribs 19, pressure to the penis fluctuates, which may result in increased stimulation. Because the ribs 19 are on the finger portions of the glove, pressure caused by them may be fluctuated by the user according to the user's needs. Thus, the utility is increased because it allows a user who does not desire strong sexual stimulations, such as an elderly person or a disabled person, to provide an adjustable and suitable stimulation. Stimulation is further increased via the aperture, described later.

Not shown in the figures, the penile stimulation device further comprises an inside portion defined between the palm side 15 and the backhand side 14, and as is well known in the art of gloves. Where the two sides are joined together, a volume is defined within. As is known in the art of gloves, an opening 15 for insertion of the human hand is provided and the human hand may then remain inside the glove 10 during use.

The glove further comprises a webbing 21 disposed between said at least one finger sleeve portion 17 and said thumb portion 18. The webbing 21 is a thin layer of highly flexible yet tear resistant material preferably comprising the same material that makes up, and is continuous with outside side 12, and itself further comprises annular membrane 22 surrounding an aperture 13. Annular membrane 22 is shown in a preferred embodiment in FIGS. 1-4 located approximately centered between said at least one finger sleeve portion 17 and said thumb portion 18, but may be positioned in various other positions on webbing 21. Annular membrane 22 may be of a size initially very small, such as one quarter of an inch or less, but that may be stretch during use by the wearer 11. In some embodiments the size of the aperture may be between one-quarter inch and one half inch, in other embodiments between one half inch and one inch. Larger sizes are detailed in alternative embodiments, up to a diameter of three inches. The size of the opening is such that in a preferred embodiment it may tightly accommodate penetration by the human male sex organ when in an erect state. The size of the opening may also be varied between devices, with some devices having a smaller opening and some devices having a larger opening.

In an alternative embodiment, the annular membrane 22 may be molded with a soft flexible lip portion formed with an undulating wall and an outer peripheral edge having a reinforced elastic rib extending around the outside of the sheath. The opening may be bordered by a textured surface for enhanced sensation to the wearer 11. The annular membrane 22 may in an alternative embodiment be an X-shaped cutline in the glove, wherein two intersecting slits make up an X in webbing 22.

Glove 10 is described with at least one opening (aperture 13) between the thumb portion 18 and at least one finger sleeve portion 17 to receive and encircle the male sexual organ and contact the outer surface peripheries of portions of the penis as desired by the user. The soft flexible webbing portion (webbing 21) at least partially connects the thumb portion 18 and at least one finger sleeve portion 17.

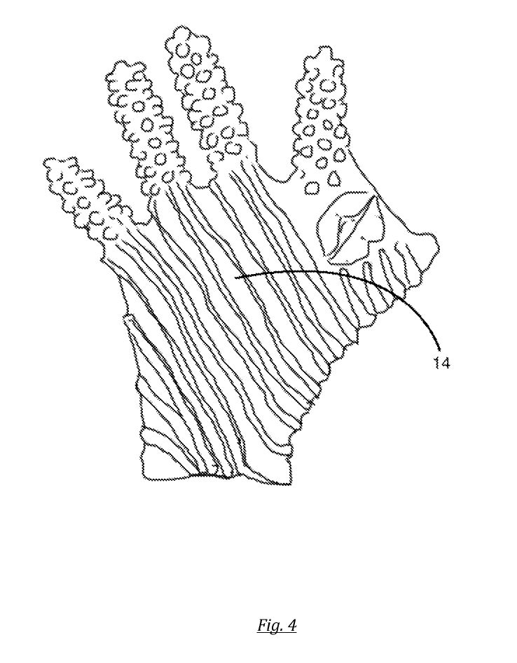

As shown on FIG. 5, glove 10 in an alternative embodiment further comprises a wrist portion 23, which may comprise at least one additional fold therein to provide additional support such that glove 10 may keep its shape when not in use, and which may allow for a larger or more consistent opening through which the wearer's hand may be inserted when using the glove. The extra fold may be supplemented or replaced with a semi-rigid ring-like structure that serves the same purpose—to maintain the structure of the glove during insertion of the wearer's hand and to prevent the glove from slipping off during use.

The inside of the glove 10 (the portion that touches the user's hand when the user's hand is inside the glove) may comprise a different material then that on the outside side 12. Because the sliding frictional forces on the inside of the glove will be highly reduced if not eliminated completely, the inside of the glove may comprise nearly any material commonly found on the inside of gloves and as is known in the art, all without departing from the functionality of the invention. That is, since the external material (outside side 12) will have the fleshy feel of skin, it is considered that the inside of the glove may comprise a different material of reduced friction. Including but not limited to cloth, sheepskin, cotton, velvet and other soft materials having a relatively low coefficient of sliding. In other embodiments, the material may be rigid to further assist in the glove maintaining its structure when not in use, or the material may be fluffy or foam-like to increase the comfort of the wearer.

Regarding all embodiments of the invention, it is to be understood that each embodiment depicts and describes various features that may be used in combination with other embodiments. Other features described in relation to each embodiment may also optionally be used, and in still another embodiment all features shown in all drawings may be combined into one glove. In yet another embodiment the glove may comprise one or all features from all drawings, but integrated into one glove.

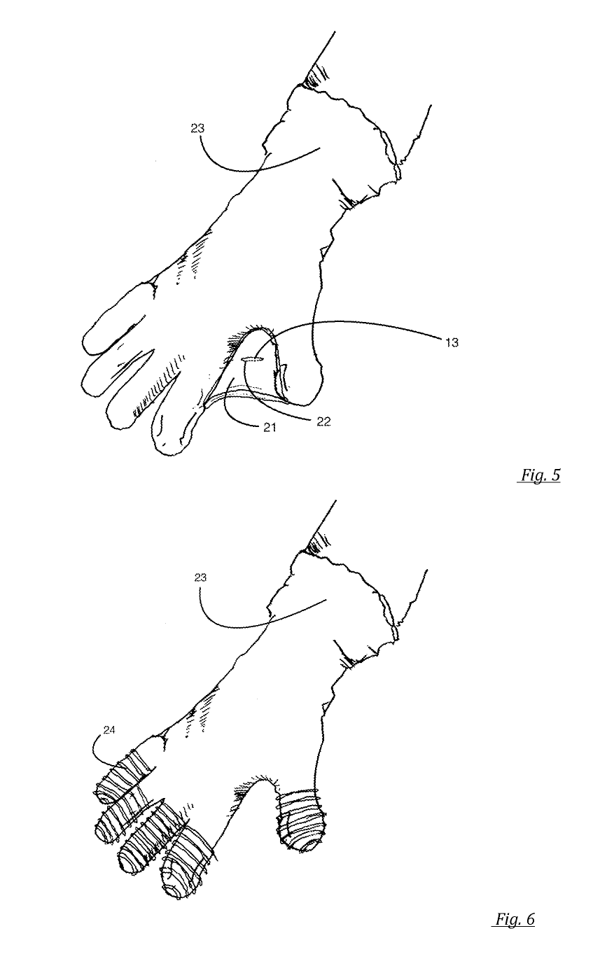

FIG. 6 highlights an alternative embodiment of the glove 10 further comprising finger ribs 24 that are not present around the remainder of the glove (see FIGS. 1-4) but that may nevertheless add to the wearer's sensation when in use. The finger ribs 24 may be molded from the same material making up the outside side of the glove, or may be affixed thereto by thermal or other suitable means. Although finger ribs 24 are shown on the thumb and each figure, they may be present on any combination of figures and/or thumb. In this figure the webbing and aperture are not shown, but as mentioned above combinations of the figures are possible wherein the webbing and aperture is present.

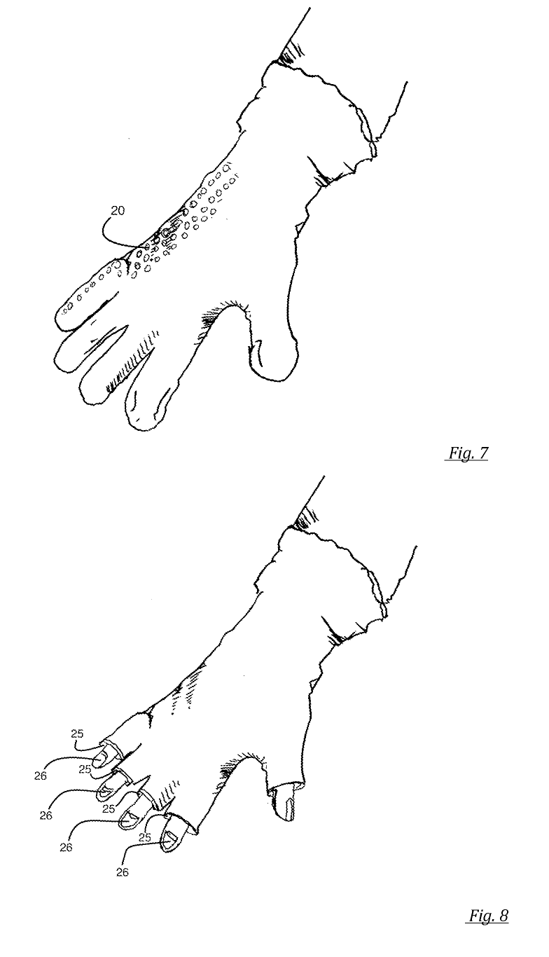

FIG. 7 highlights another aspect of the present invention, wherein bumps or raised protuberances are present only on portions of the glove 10. In use, the effect on the user's penis is similar to that described with respect to FIG. 6. The protuberances may be replaced with other textured surfaces, such as indentations, crosses, waffle like surfaces, and the like.

FIG. 8 depicts another embodiment of the invention wherein the glove 10 comprises finger openings 25 through which the user's fingers 26 may be extended therethrough. This may serve the same effect of increasing sensation and control as described above with respect to the other figures. The opening may also accommodate users having longer fingernails.

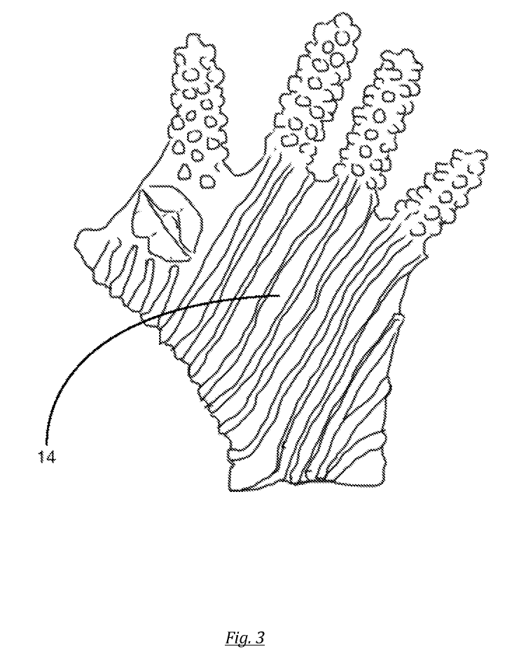

In all embodiments, the device may alternatively be thicker than shown in the images, having an extra layer or layers of padding between the user's hand and the external layer of the device. In these embodiments the device may include silicone or other soft inserts between the inner layer and outer layer. In all embodiments, the device may be fitted for either the right hand (see FIG. 3) or the right hand (see FIG. 4).

The device may aid in masturbation or collection of sperm of a human male, and provides a clean barrier between the male organ and the wearer's hands. For instance, if the wearer's hands are unclean and the wearer desires a clean surface, the wearer may put his hand inside the glove, thereby protecting the male organ from the unclean hands. If the male wearer's (or female wearer's) hands are unclean and the wearer desires to physically contact either another male or female, the device allows the wearer to do so in a clean manner. Similarly, if lubricant or other materials are placed on the glove prior to use, the wearer's hand may be protected from such substances. In other embodiments the human male may use the device when the wearer's hand is inaccessible, such as when the wearer is in a hand a cast or other forms of gloves. Although the term “wearer” has been used in this application to describe the user of the device also wearing the device as a glove, in other instances the wearer of the device may be using the device on another male, rather than wearer herself or himself.

In addition to being used as a device to aid in masturbation of a human male, the device may thus also be used for the sexual stimulation of others and may be used in the animal breeding industry for the sexual stimulation of horses, bulls, and other animals for breeding purposes. Finally, in certain embodiments the invention may also be used for massage purposes.

With respect to the above description then, it is to be realized that material disclosed in the applicant's drawings and description may be modified in certain ways while still producing the same result claimed by the applicant. Such variations are deemed readily apparent and obvious to one skilled in the art, and all equivalent relationships to those illustrated in the drawings and equations and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact disclosure shown and described, and accordingly, all suitable modifications and equivalents may be resorted to, falling within the scope of the invention.

I claim:

1. A glove to aid in the ejaculation of a male, the glove comprising:
a. an outside side comprising a backhand side and a palm side joined together to fit a human hand, wherein said backhand side is formed and disposed so as to overlie the back of the hand when worn by the wearer, said palm side comprises a palm face portion and at least one finger sleeve portion, wherein said palm face portion comprises a plurality of ribs and said at least one finger sleeve portion comprises a plurality of protuberances;
b. an inside defined by said palm side and said backhand side joined together and comprising an opening for insertion of said human hand;
c. a webbing disposed between and connecting said at least one finger sleeve and a thumb portion;
d. an aperture in said webbing.

2. The glove according to claim 1 wherein said webbing is connected to one of said ribs.

3. The glove according to claim 1 wherein said webbing is stretched between said at least one finger sleeve portion and said thumb portion.

4. The glove according to claim 1 wherein said aperture is surrounded by an annular membrane.

5. The glove according to claim 1 further comprising a plurality of finger sleeves.

6. The glove according to claim 5 wherein each finger sleeve of said plurality of finger sleeves has a proximal end connected to said palm face portion and an open distal end extending away from said palm face portion such that a finger may extend through the distal end when the glove is worn.

7. The glove according to claim 1, the glove comprising no more than one aperture in said webbing.

8. A glove to aid in ejaculation, the glove comprising:
a. a full-handed glove covering all four fingers and thumb, the glove having an outside side facing away from the four fingers and thumb, and an inside side facing toward the four fingers and thumb;
b. at least one finger sleeve portion and a thumb portion;
c. a webbing disposed between said at least one finger sleeve portion and said thumb portion;
d. an aperture in said webbing; and
e. wherein said outside side comprises a plurality of ribs and a plurality of protuberances.

9. The glove according to claim 8 wherein said webbing is connected to one of said ribs.

10. The glove according to claim 8 wherein said webbing is stretched between said at least one finger sleeve portion and said thumb portion.

11. The glove according to claim 8 wherein said aperture is surrounded by an annular membrane.

12. The glove according to claim 8 further comprising a plurality of finger sleeves.

13. The glove according to claim 12 wherein each finger sleeve of said plurality of finger sleeves has a proximal end connected to said palm face portion and an open distal end extending away from said palm face portion such that a finger may extend through the distal end when the glove is worn.

14. The glove according to claim 8, the glove comprising no more than one aperture in said webbing.
